(19) United States
(12) Patent Application Publication
(10) Pub. No.: US 2005/0261030 A1
(43) Pub. Date: Nov. 24, 2005

(54) Mobile communication device

(75) Inventor: Luc Vacquie, Saint Jean L'Herm (FR)

Correspondence Address: YOUNG & THOMPSON, 745 SOUTH 23RD STREET, 2ND FLOOR, ARLINGTON, VA, 22202, US

(73) Assignee: France Telecom, Paris (FR)

(21) Appl. No.: 10/521,968

(22) PCT Filed: Jul. 1, 2003
(86) PCT No.: PCT/FR03/02042

§ 371 Date: Jan. 21, 2005

(30) Foreign Application Priority Data
Jul. 22, 2002 (FR) 02/09290

(51) Int. Cl. H04M 1/00; H04B 1/38

(52) U.S. Cl. 455/566

(57) ABSTRACT

A mobile telecommunication device of the type having of an information transmitter/receiver, an information display screen (4), a user control interface and a processor including execution software, which is used to process and execute the numerous functions integrated in the device. The device includes elements for monitoring and analysing information received by the receiver and elements for generating at least one pictogram (40) comprising attributes which can at least be modified under the control of the monitoring and analysis elements, in order to notify a user of the receipt of information. The pictogram (40) can be displayed on the display screen (4) in order to form a man/machine interface. The device also includes activation zones (42, 50) used to activate the device's integrated functions, which can be accessed by the user via the control interface of the device in order to enable activation of the corresponding functions.

The present invention relates to a mobile telecommunications device of the type including an information sender/receiver, an information display screen, a user control interface, a processor and software for execution by said processor of a plurality of functions integrated into the device.

Devices of the above kind are in widespread use and have an increasing number of functions such as contacts lists, information exchange, access to picture and sound data, access to information transfer networks (e.g. the Internet), and a large number of adjustment and personalization functions.

Furthermore, such devices routinely enable reception of information of diverse kinds such as telephone calls, facsimile calls, short text messages and electronic mail.

The increase in the capacities of telecommunications devices is also leading to an increase in the complexity of their man/machine interfaces, which usually consist of cascaded menus or functions, making the use of such devices not particularly user friendly.

The object of the invention is to solve this problem by proposing a mobile telecommunications device enabling user friendly management of integrated functions.

The present invention consists in a mobile telecommunications device of the type including an information transceiver, an information display screen, a user control interface, a processor, and software for execution by said processor of a plurality of functions integrated into the device, which is characterized in that it further comprises monitoring means adapted to analyze information received by said sender/receiver and means for generating a pictogram for notifying the user of the reception of information and having attributes modifiable at least under the control of said monitoring and analysis means, which pictogram may be displayed on said display screen to form a man/machine interface and further comprises areas for activating functions integrated into said device accessible by the user via said control interface of the device to activate corresponding functions.

According to other features of the invention:
the device further comprises means for monitoring the operating status of the device and said means for generating the pictogram with modifiable attributes are also under the control of said means for monitoring the operating status of the device for the purposes of notifying the user of the operating status of the device;
the device further comprises means for setting parameters of the pictogram and said means for generating the pictogram with modifiable attributes are also under the control of said parameter setting means in order to generate a pictogram as a function of the parameter setting means;
said parameter setting means are adapted to deliver to said pictogram generation means instructions to create and/or modify activation areas of said pictogram with modifiable attributes;
at least one of said activation areas corresponds to portions of said pictogram whose activation leads to the display thereof to a larger scale, thereby authorizing access by the user to a plurality of associated other activation areas;
the device comprises a pictogram memory associated with said pictogram generation means and the activation of certain activation areas of a first pictogram leads to the display of another pictogram with modifiable attributes generated by said pictogram generation means from pictograms contained in said memory;
the device comprises another man/machine interface providing access to all of the functions integrated into the device and said pictogram comprises an activation area for selecting the other man/machine interface;
the device comprises a sequencer adapted to activate said means for generating the pictogram to display a default pictogram on said display screen after a predetermined time of inactivity of the device;
said pictogram is anthropomorphic;
the device comprises at least one activation area selected from the group comprising:
   an activation area for contact list type functions level with the brain of said anthropomorphic pictogram;
   an activation area for sound functions level with an ear of said anthropomorphic pictogram;
   an activation area for visual functions level with an eye of said anthropomorphic pictogram;
   an activation area for personalization functions level with the heart of said anthropomorphic pictogram; and
   an activation area for functions relating to short text messages level with a hand of said anthropomorphic pictogram.

The invention will be better understood after reading the following description, which is given by way of example only and with reference to the appended drawings, in which:

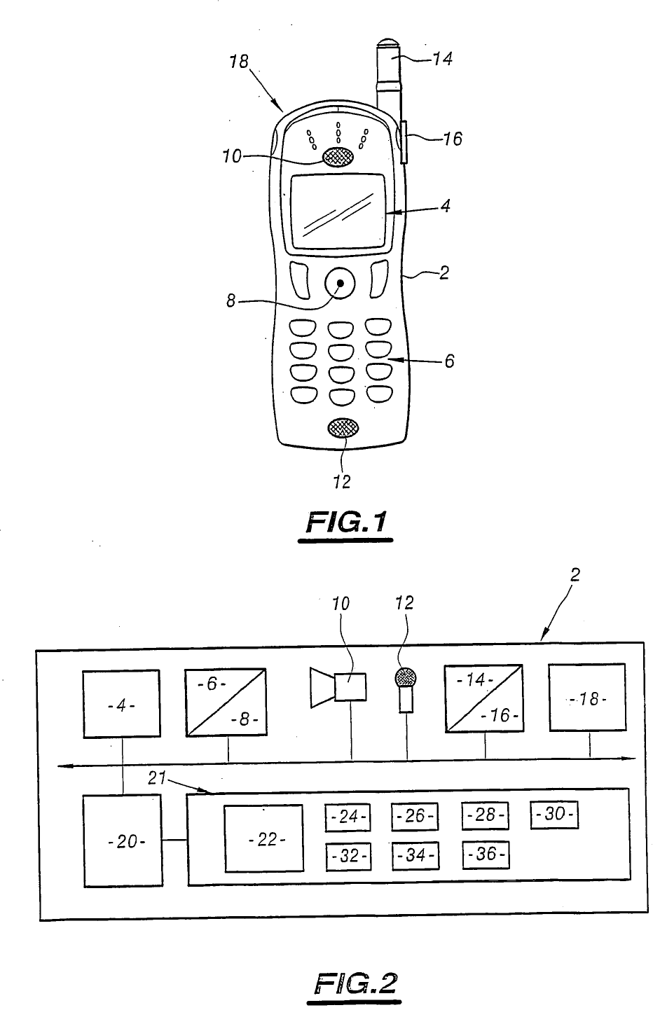

FIG. 1 represents one embodiment of a mobile telecommunications device;

FIG. 2 is a functional block diagram of a mobile telecommunications device of the invention; and

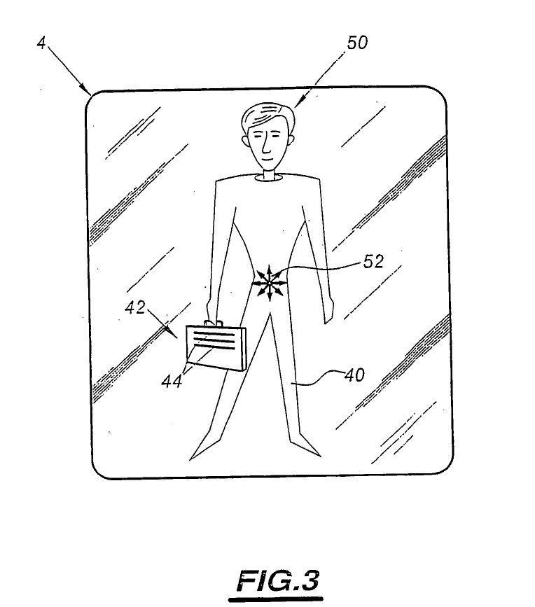

FIGS. 3, 4 and 5 represent the screen of the device described with reference to FIG. 2 with different levels of detail.

FIG. 1 represents a mobile telecommunications device, to be more precise a mobile telephone 2.

The mobile telephone 2 comprises a display screen 4 and a control interface consisting of a keypad 6 and a multiway button 8, for example.

The mobile telephone 2 also comprises a loudspeaker 10, a microphone 12, means for sending and receiving information, in the form of an antenna 14 for wireless radio communication and an infrared interface 16, for example, and a rechargeable power supply in the form of a battery 18.

FIG. 2 is a functional block diagram of the telecommunications device described with reference to FIG. 1 comprising equipment conforming to the invention.

This diagram shows the mobile telephone 2, the display screen 4, the control interface 6, 8, the loudspeaker 10, the microphone 12, the information send and receive means 14, 16, and the battery 18.

All the above components are interconnected and are controlled by a processor 20 associated with a memory 21 that contains software 22 for executing a plurality of functions.

In the conventional way, the software 22 is referred to as the “operating system” and is adapted to implement all the functions of the mobile telephone 2.

According to the invention, the mobile telephone 2 also comprises means 24 for generating a pictogram that has modifiable attributes and may be displayed on said display screen 4 to provide a man/machine interface.

The pictogram generation means 24 are connected to monitoring means 26 adapted to analyze information received via the information sender/receiver 14, 16 and to means 28 for monitoring the operating status of the mobile telephone 2, means 30 for setting parameters of the pictogram displayed and a pictogram memory 32, in order to receive from these components information for modifying attributes of the pictogram to be generated.

Thus the pictogram generation means 24 generate a pictogram that is selected in the memory 32 and whose attributes are modified as a function of information supplied by the monitoring means 26 adapted to analyze information received and the means 28 for monitoring the operating status of the telephone 2 and as a function of instructions delivered by the parameter setting means 30.

According to the invention, the pictogram generated by the means 24 further comprises areas for activation of functions integrated into the telephone 2.

These activation areas are monitored by monitoring means 34 and are accessed by the user of the telephone 2 via the control interface 6, 8 to activate functions of the operating system 22, as described below in more detail.

Finally, the device comprises a sequencer 36 adapted to trigger the pictogram generation means 24 as a function of time and of actions effected by a user via the control interface 6, 8.

The means 24, 26, 28, 30, 34 and 36 consist of software written in Java, for example, and some or all of them may be integrated into the memory 21 of the telephone 2 from the outset or downloaded into it during use of the telephone 2.

Similarly, the pictogram memory 32 may be integrated into the memory 21 from the outset or created and/or completed during use of the telephone 2.

FIG. 3 represents one embodiment of the device of the invention as described with reference to FIGS. 1 and 2 and FIG. 3 represents more particularly the display screen 4 of the telephone 2, on which an anthropomorphic pictogram 40 is displayed.

For example, this pictogram 40 is a default pictogram that is displayed by default and at the command of the sequencer 36 after a predetermined time for which the control interface 6, 8 has been connected.

Being generated by the means 24 that are under the control of the means 28 for monitoring the operating status of the telephone 2, the pictogram 40 is representative of that status.

For example, the means 28 for monitoring the operating status of the telephone 2 verify the state of charge of the battery 18 and supply corresponding information to the pictogram generation means 24 that generate the pictogram 40 so that the brightness and/or color of the pictogram 40 indicate(s) the state of charge of the battery 18.

Similarly, a symbol level with the ears of the pictogram 40 advises a user as to the status of the ringer functions of the telephone 2. For example, a blocked ear indicates that the ringer of the telephone 2 is disabled.

The pictogram 40 is also generated under the control of the monitoring means 26 adapted to analyze information received in order to notify the user that information has been received.

For example, if the telephone 2 receives three new SMS short text messages, the reception of the messages is detected by the monitoring and analysis means 26, which supply corresponding information to the means 24 for generating the pictogram 40, as a result of which the said pictogram then includes a briefcase 42 on which three horizontal strips 44 indicate three new SMS messages.

The pictogram 40 generated by the means 24 is therefore representative of the operating status of the telephone 2 and of information received, in order to notify the user of the reception of the information.

Also, the pictogram comprises a plurality of activation areas, such as the briefcase 42 or the face 50, accessible to the user via a control for moving a cursor 52 on the display screen 4 and associated with a multiway button of the control interface of the telephone.

In the example described, the cursor 52 is originally located over the abdomen of the pictogram 40 and the user may move it in eight cardinal directions by means of the multiway button 8.

As a general rule, functions relating to SMS message are located level with the hand of the pictogram 40, to be more precise level with the briefcase 42.

The user may activate the activation area 42 corresponding to the briefcase simply by moving the cursor 52 in its direction or by placing it on top of the briefcase and validating that position, for example by pressing a key of the keypad 6.

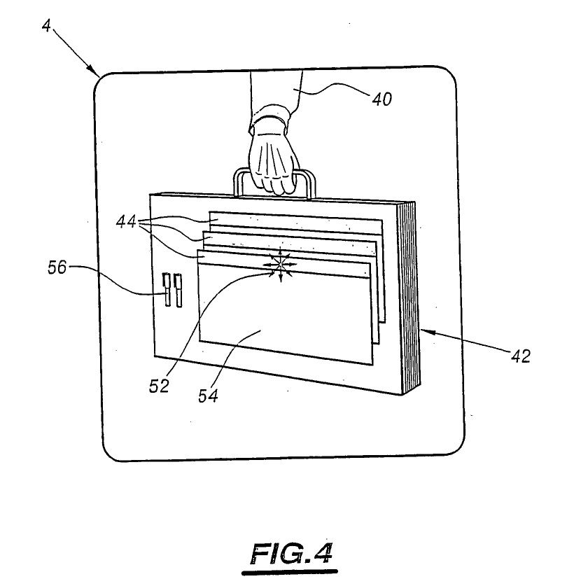

This is reflected in the display of the briefcase 42 of the pictogram 40 on the screen 4 to a larger scale, as represented in FIG. 4.

In this enlarged display, the horizontal strips 44 are each a header of a sheet 54 and show an identifier of the sender of the text message, for example, the sheets 54 containing the messages.

The enlarged display of the briefcase 42 also shows associated new activation areas, such as an activation area 56 corresponding to a pen and representing an area for activating functions for writing SMS messages.

By moving the cursor 52, the user is able to access new SMS messages received or compose a message to send.

For example, if the user moves the cursor 52 to the right, the sheets 54 are interchanged to enable all the new messages to be read.

Furthermore, if the user moves the cursor 52 towards the pen 56, or positions the cursor 52 on top of the pen and validates that position, the activation area 56 reacts in a similar manner to an icon, causing the operating system 22 execute the function for writing messages.

Of course, the briefcase symbol 42 may also be used to indicate the reception of facsimile messages, electronic mail, missed calls or any other characteristic relating to the reception of information.

By moving the cursor 52 towards the hand of the pictogram 40, and thus in the direction of the central position corresponding to the abdomen, the user may revert to the normal size display as represented in FIG. 3.

Of course, if the user has read the new SMS messages, the pictogram generated by the means 24 no longer comprises any horizontal strips 44 on the briefcase 42, indicating that there are no new text messages.

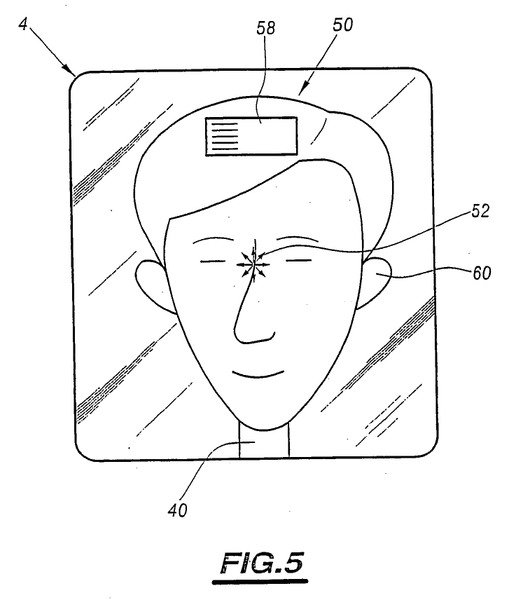

The user may move the cursor toward the activation area corresponding to the face 50 from the central position 52 over the abdomen of the pictogram 40, as represented in FIG. 3, or directly from the enlarged display of the briefcase 42, as represented in FIG. 4. This causes the activation area 50 to be displayed to a larger scale, as represented in FIG. 5.

The user is then able to move the cursor 52 between various associated new activation areas distributed over the face 50 of the pictogram 40 displayed in close-up, in order to access certain functions of the telephone 2.

For example, moving the cursor 52 towards the activation area 58 corresponding to the brain activates functions relating to the contact lists 2 and in particular to storing new contacts. Similarly, moving the cursor 52 towards the ear 60 activates functions relating to the sound characteristics of the telephone 2, and in particular to activation and deactivation of the ringer.

Of course, other examples and configurations may be envisaged.

For example, an activation area for visual functions is provided level with an eye of the pictogram 40, a personalization function activation area over the heart, etc.

If the same portion of the pictogram 40 is used both as an activation area and to notify the user of the reception of information or the operating status of the device 2, the device is adapted to switch between these two functions.

For example, a portion of the keypad 6 of the control interface of the device is used to switch between two modes of operation. In one of these modes of operation, the activation areas are accessible and are shown brighter than information notified to the user, and vice-versa in the other mode of operation.

For example, the clothing of the upper portion of the pictogram is used to notify the user of the reception of electronic mail and the heart of the pictogram 40 is an activation area providing access to personal files. The control interface is then used to switch between two modes of operation, one providing access to electronic mail and the other providing access to the heart activation area.

The arrangement of the activation areas enables the user to learn how the device 2 works intuitively, in particular through the use of an anthropomorphic pictogram and the distribution of the activation areas over the pictogram 40 in such a way that corresponding functions relate to the position of the area on the pictogram 40.

Accordingly, when the device is displaying a portion of the pictogram to a larger scale, the user is not obliged to revert to the normal scale display shown in FIG. 3 to access the larger scale display of another portion of the pictogram, but may access the larger scale display directly by moving the cursor 52 in the appropriate direction; this makes the device even more user friendly.

Moreover, a user is able to make a certain number of modifications to the pictogram 40 by means of the parameter setting means 30.

To this end the parameter setting means 30 deliver display instructions to the means 24 for generating a pictogram 40 so that said pictogram conforms to the parameters entered by a user.

For example, these modifications might move an activation area to a selected portion of the pictogram 40 or create a new activation area.

For simplicity, the pictogram 40 does not provide access to all of the functions that may be executed by the operating system 22, and it is therefore necessary to provide means for accessing all the functions, for example by activating another conventional man/machine interface consisting of pull-down menus.

This may be effected by moving the cursor 52 over a particular activation area of the pictogram 40, for example, or by manipulating the control interface by holding down a key of the keypad 6 for a predetermined time.

Furthermore, control interfaces other than those described may be used, such as voice control, a thumbwheel, a touch-sensitive screen, or any other suitable interface.

Also, a plurality of entirely or partly anthropomorphic pictograms may be used to enable access to the various functions of the device 2, a new pictogram being displayed by activating an activation area.

In another embodiment, one portion of the control interface is dedicated to managing the scale of the display, to enable display with a variable level of detail, and another portion of the control interface is used to move between activation areas and displayed data as a function of the scale of the display.

The invention described may also be adapted to other types of device, such as personal digital assistants (PDA) or any other mobile device adapted to receive information and integrating a plurality of functions.

It is therefore apparent that the invention provides a simple way to synthesize characteristics relating to the reception of information and to the operating status of the device and also provides fast and user friendly access to functions integrated into the device.

1-10. (canceled)

11. A mobile telecommunications device (2) of the type including an information sender/receiver (14, 16), an information display screen (4), a user control interface (6, 8), a processor (20), and software (22) for execution by said processor (20) of a plurality of functions integrated into the device (2), further comprising monitoring means (26) adapted to analyze information received by said sender/receiver (14, 16) and means (24) for generating a pictogram (40) for notifying the user of the reception of information and having attributes modifiable at least under the control of said monitoring and analysis means (26), which pictogram (40) may be displayed on said display screen (4) to form a man/machine interface and further comprises areas (42, 50) for activating functions integrated into said device (2) accessible by the user via said control interface (6, 8) of the device (2) to activate corresponding functions.

12. A device according to claim 11, further comprising means (28) for monitoring the operating status of the device (2) and said means (24) for generating the pictogram (40) with modifiable attributes are also under the control of said means (28) for monitoring the status of the device (2) for the purposes of notifying the user of the operating status of the device (2).

13. A device according to claim 11, further comprising means (30) for setting parameters of the pictogram (40) with modifiable attributes and said means (24) for generating the pictogram (40) are also under the control of said parameter setting means (30) in order to generate a pictogram (40) as a function of the parameter setting means (20).

14. A device according to claim 13, wherein said parameter setting means (30) are adapted to deliver to said pictogram generation means (24) instructions to create and/or modify activation areas of said pictogram (40) with modifiable attributes.

15. A device according to claim 11, wherein at least one of said activation areas (42, 50) corresponds to portions of said pictogram (40) whose activation leads to the display thereof to a larger scale, thereby authorizing access by the user to a plurality of associated other activation areas (56, 58, 60).

16. A device according to claim 11, comprising a pictogram memory (32) associated with said pictogram generation means (24) and the activation of certain activation areas of a first pictogram (40) leads to the display of another pictogram with modifiable attributes generated by said pictogram generation means (24) from pictograms contained in said memory (32).

17. A device according to claim 11, comprising another man/machine interface providing access to all of the functions integrated into the device (2) and said pictogram (40) comprises an activation area for selecting the other man/machine interface.

18. A device according to claim 17, comprising a sequencer (36) adapted to activate said means (24) for generating the pictogram (40) to display a default pictogram on said display screen (4) after a predetermined time of inactivity of the device (2).

19. A device according to claim 11, said pictogram being anthropomorphic.

20. A device according to claim 19, comprising at least one activation area selected from the group comprising:
an activation area for contact list type functions level with the brain of said anthropomorphic pictogram (40);
an activation area for sound functions level with an ear of said anthropomorphic pictogram (40);
an activation area for visual functions level with an eye of said anthropomorphic pictogram (40);
an activation area for personalization functions level with the heart of said anthropomorphic pictogram (40); and
an activation area for functions relating to short text messages level with a hand of said anthropomorphic pictogram (40).
